(19) United States
(12) Patent Application Publication
(10) Pub. No.: US 2019/0186838 A1
(43) Pub. Date: Jun. 20, 2019

(54) WATER-COOLING DEVICE

(71) Applicant: ASIA VITAL COMPONENTS CO., LTD., New Taipei City (TW)

(72) Inventor: Ching-Hang Shen, New Taipei City (TW)

(21) Appl. No.: 16/283,824

(22) Filed: Feb. 25, 2019

Related U.S. Application Data
(63) Continuation of application No. 15/183,793, filed on Jun. 16, 2016.

(51) Int. Cl. F28D 15/00; F04D 13/06; F28F 3/02; F28F 9/00; F04D 29/22

(52) U.S. Cl. CPC F28D 15/00; F04D 13/0693; F28F 3/02; F28D 2021/0028; F04D 29/2261; F05B 2280/5008; F28F 9/001

(57) ABSTRACT

A water-cooling device includes a pump case, at least one winding, a driver and a heat exchange member. The pump case has a top section, a bottom section and a peripheral section together defining a pump chamber. The winding is disposed on a circuit board. The circuit board is disposed on any of the top section, the bottom section and the peripheral section. The driver is disposed in the pump chamber. At least one magnetic member is disposed on the driver in a position corresponding to the winding, whereby the magnetic member can induce and magnetize the winding on the circuit board. The heat exchange member is connected with the pump case. By means of the structural design of the water-cooling device, the volume of the water-cooling device is greatly minified and the structure of the water-cooling device is thinned.

The present application is a continuation of U.S. patent application Ser. No. 15/183,793, filed on Jun. 16, 2016.

### BACKGROUND OF THE INVENTION

### 1. Field of the Invention

The present invention relates generally to a water-cooling device, and more particularly to a water-cooling device the total volume of which is greatly minified and the structure of which is thinned.

### 2. Description of the Related Art

It is known that the operation function of the current computer has become stronger and stronger. Also, the operation speed of the current computer has become higher and higher. Moreover, as a whole, the configuration, structure and the motherboard connection manner of the current computer have been improved to break through the set pattern. This is a very important revolution in the computer field. The new-generation central processing unit has ultrahigh operation speed. As a result, when the central processing unit processes the operation commands, the heat generated by the central processing unit is much higher. Therefore, it has become a critical issue in this field how to use a heat dissipation system with good heat conductivity to lower the temperature and make the central processing unit normally work at an allowable temperature.

In a conventional water-cooling device, the heat of a heat generation component (CPU or GPU) is absorbed and heat-exchanged with a cooling liquid in the water-cooling device. Then, a pump in the water-cooling device is used to circulate the cooling liquid. The water-cooling device is connected to a heat sink via multiple pipe bodies, whereby the cooling liquid can circulate and perform heat exchange between the heat sink and the water-cooling device to dissipate the heat. In this case, the heat of the heat generation component can be quickly dissipated.

However, the conventional water-cooling device includes a traditional stator assembly composed of multiple windings and stacked silicon steel sheets. Therefore, the conventional water-cooling device has a considerable thickness and volume. As a result, the structure of the conventional water-cooling device will lead to an excessively large volume and cannot be thinned.

### SUMMARY OF THE INVENTION

It is therefore a primary object of the present invention to provide a water-cooling device the total volume of which is greatly minified.

It is a further object of the present invention to provide the above water-cooling device the structure of which is thinned.

To achieve the above and other objects, the water-cooling device of the present invention includes a pump case, at least one winding, a driver and a heat exchange member. The pump case has a top section, a bottom section and a peripheral section together defining a pump chamber. The winding is disposed on a circuit board. The circuit board is disposed on any of the top section, the bottom section and the peripheral section. The driver is disposed in the pump chamber. At least one magnetic member is disposed on the driver in a position corresponding to the winding. The heat exchange member is connected with the pump case. The heat exchange member has multiple radiating fins and is formed with a heat exchange chamber. The heat exchange chamber communicates with the pump chamber for a cooling liquid to pass through.

According to the structural design of the present invention, the magnetic member is disposed on the driver in a position corresponding to the winding, whereby the magnetic member can induce and magnetize the winding on the circuit board. Under the induction and magnetization between the magnetic member and the winding, the silicon steel sheets of the conventional water-cooling device can be saved so as to greatly minify the total volume of the water-cooling device and thin the structure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the water-cooling device of the present invention;

FIG. 2 is a perspective assembled view of the first embodiment of the water-cooling device of the present invention;

FIG. 3 is a sectional view of the first embodiment of the water-cooling device of the present invention;

FIG. 4 is a sectional view of a second embodiment of the water-cooling device of the present invention;

FIG. 5 is a sectional view of a third embodiment of the water-cooling device of the present invention; and

FIG. 6 is a sectional view of a fourth embodiment of the water-cooling device of the present invention.

### DETAILED DESCRIPTION OF THE PREFERRED EMBODIMENTS

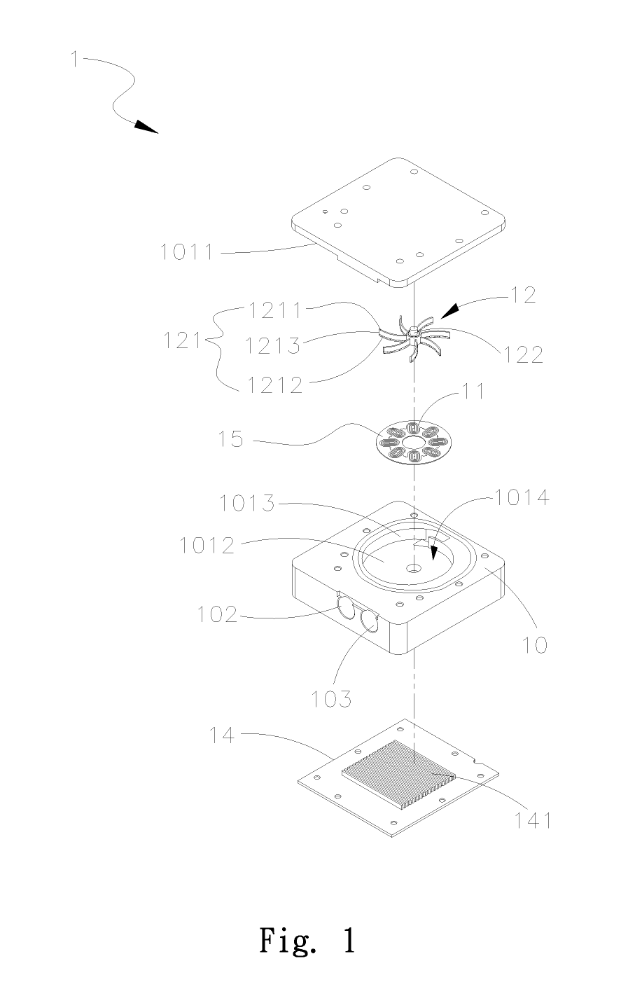

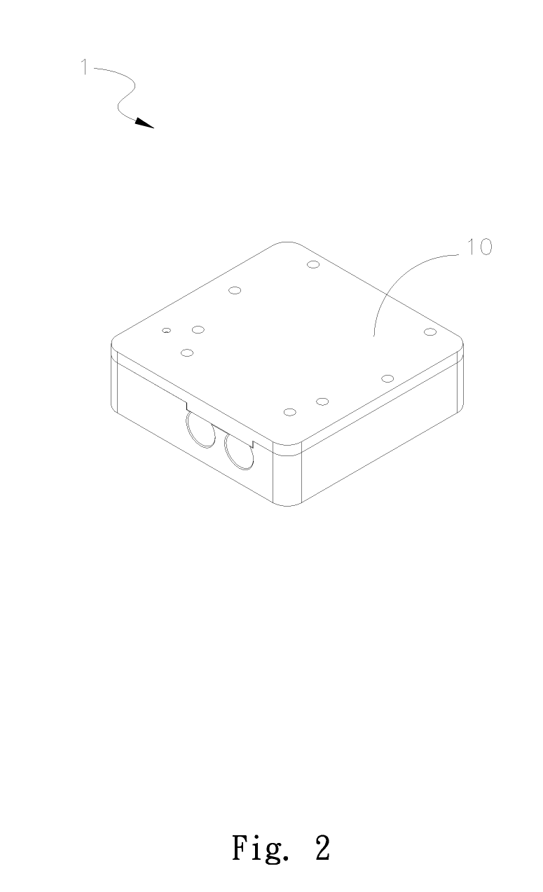

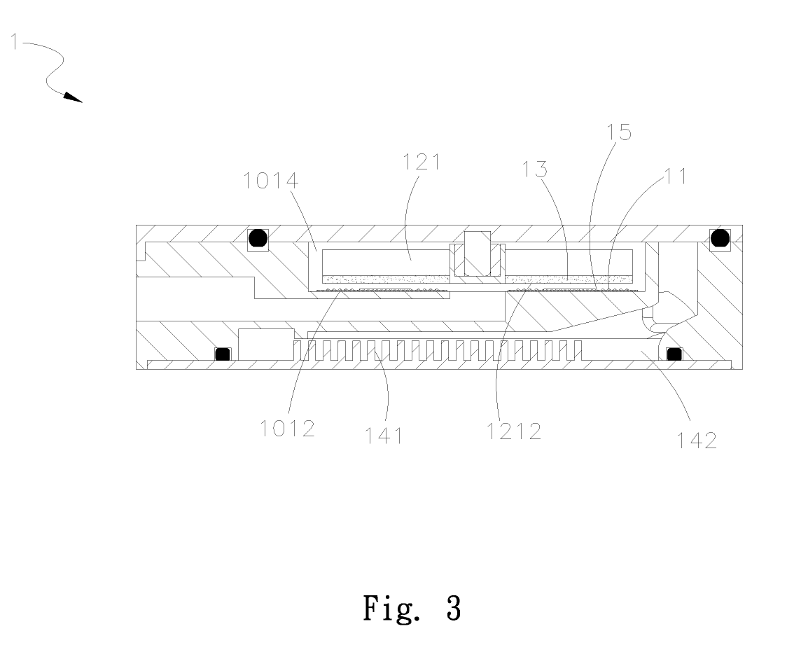

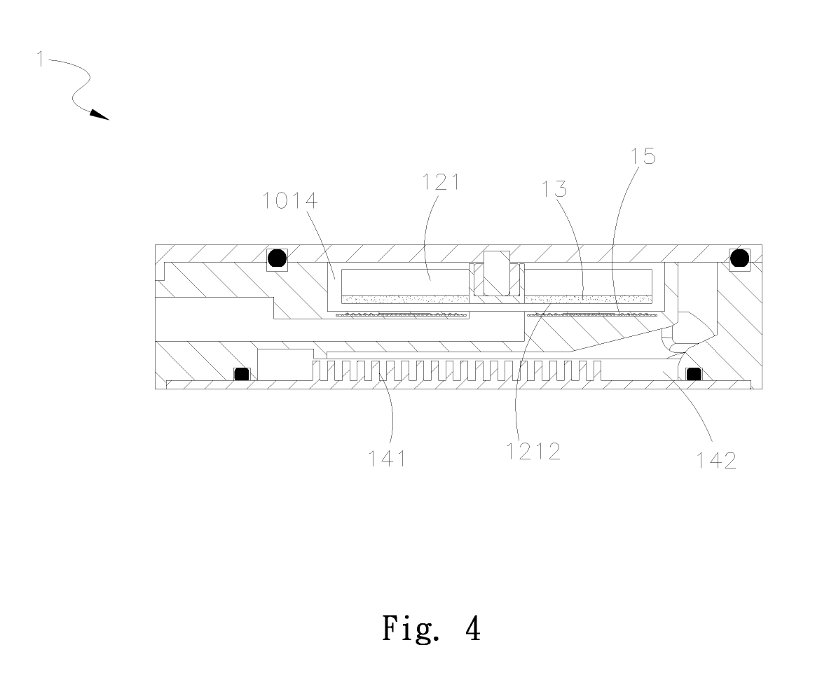

Please refer to FIGS. 1, 2 and 3. FIG. 1 is a perspective exploded view of a first embodiment of the water-cooling device of the present invention. FIG. 2 is a perspective assembled view of the first embodiment of the water-cooling device of the present invention. FIG. 3 is a sectional view of the first embodiment of the water-cooling device of the present invention. According to the first embodiment, the water-cooling device 1 of the present invention includes a pump case 10, at least one winding 11, a driver 12 and a heat exchange member 14. The pump case 10 has a top section 1011, a bottom section 1012 and a peripheral section 1013 together defining a pump chamber 1014. The pump case 10 has an inlet 102 in communication with an outlet 103. The winding 11 is disposed on a circuit board 15. (The winding 11 can be formed/disposed on the circuit board 15 by means of printing, stacking, etching or layout). The circuit board 15 can be selectively disposed on any of the top section 1011, the bottom section 1012 and the peripheral section 1013. A power wire (not shown) is used to electrically connect the circuit board 15 to outer side for powering the water-cooling device 1, whereby the water-cooling device 1 can normally work. In this embodiment, the winding 11 is, but not limited to, disposed on the circuit board 15 by means of printing. In practice, the winding 11 can be disposed on the circuit board 15 by means of layout or stacking according to the requirement of a user. In a modified embodiment, the circuit board 15 can be embedded in the inner wall face of any of the top section 1011, the bottom section 1012 and the peripheral section 1013 by integral injection over-molding (as shown in FIG. 4).

The driver 12 is disposed in the pump chamber 1014. The driver 12 is made of a nonmetal material (such as plastic, rubber or polymer synthetic material). The driver 12 has a central shaft 122 and multiple blades 121. Each blade 121 has an upper edge 1211, a lower edge 1212 and a lateral edge 1213. At least one magnetic member 13 is disposed on the upper edge 1211, the lower edge 1212 or the lateral edge 1213 of the blade 121 in a position corresponding to the winding 11.

The heat exchange member 14 is connected with the pump case 10. The heat exchange member 14 has multiple radiating fins 141 and is formed with a heat exchange chamber 142. The heat exchange chamber 142 communicates with the pump chamber 1914 for a cooling liquid (not shown) to pass through. The radiating fins 141 are arranged at intervals or intersect each other. The radiating fins 141 are in contact with the cooling liquid in the heat exchange chamber 142.

Please further refer to FIG. 3. In this embodiment, the circuit board 15 is disposed on the surface of the bottom section 1012. The magnetic member 13 is correspondingly disposed on the lower edge 1212 of the blade 121. In this case, the magnetic member 13 can face the winding 11 on the circuit board 15 to induce and magnetize the winding 11. Under the induction and magnetization between the magnetic member 13 and the winding 11, the driver 12 is operated to drive the cooling liquid in the water-cooling device 1 to sequentially pass through the inlet 102, the pump chamber 1014, the heat exchange chamber 142 and the outlet 103. The cooling liquid heat-exchanges with the radiating fins 141 to dissipate the heat. This can save the silicon steel sheets of the conventional water-cooling device and greatly minify the total volume of the water-cooling device 1 and thin the structure.

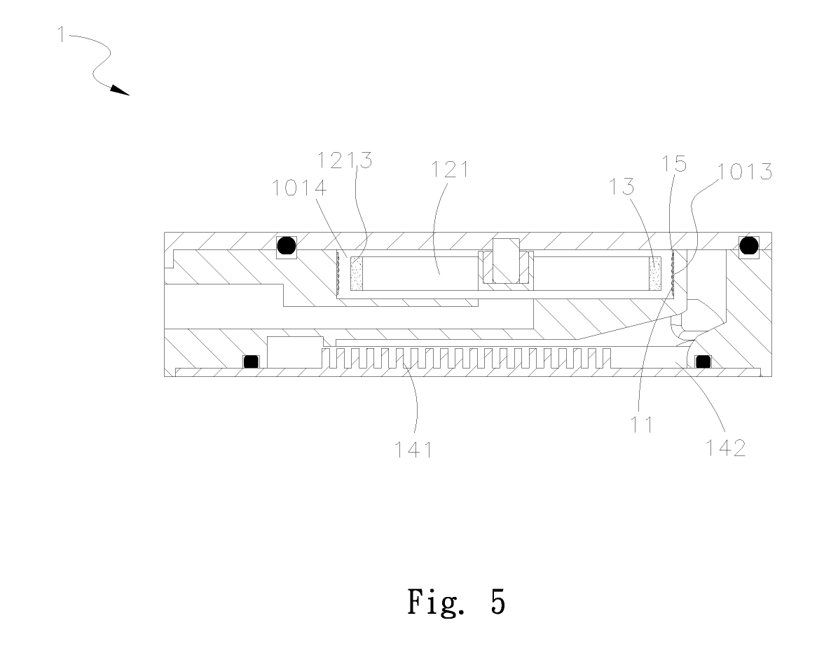

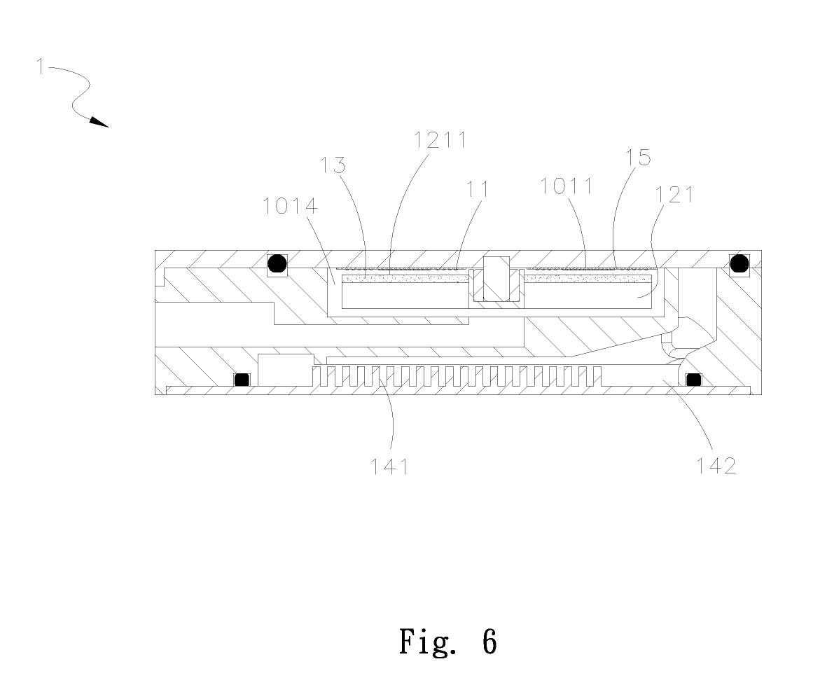

Please refer to FIGS. 5 and 6 and supplementally to FIG. 1. FIG. 5 is a sectional view of a third embodiment of the water-cooling device of the present invention. FIG. 6 is a sectional view of a fourth embodiment of the water-cooling device of the present invention. The third and fourth embodiments are partially identical to the first embodiment in component and relationship between the components and thus will not be repeatedly described hereinafter. The third embodiment is mainly different from the first embodiment in that the circuit board 15 is disposed on the peripheral section 1013 and the magnetic member 13 is correspondingly disposed on the lateral edge 1213 of the blade 121 (as shown in FIG. 5). The fourth embodiment is mainly different from the first embodiment in that the circuit board 15 is disposed under the top section 1011 and the magnetic member 13 is correspondingly disposed on the upper edge 1211 of the blade 121 (as shown in FIG. 6). This can also create magnetization between the winding 11 on the circuit board 15 and magnetic member 13 and achieve the same effect as the first embodiment.

In conclusion, in comparison with the conventional water-cooling device, the present invention has the following advantages:

1. The total volume of the water-cooling device is greatly minified.

2. The structure of the water-cooling device is thinned.

The present invention has been described with the above embodiments thereof and it is understood that many changes and modifications in the above embodiments can be carried out without departing from the scope and the spirit of the invention that is intended to be limited only by the appended claims.

What is claimed is:

1. A water-cooling device comprising:
a pump case having a top section, a bottom section, and a peripheral section together defining a pump chamber;
at least one winding formed on a circuit board, the circuit board being disposed on any of the top section, the bottom section, and the peripheral section;
a driver disposed in the pump chamber and having a central shaft and multiple blades, each blade having an upper edge, a lower edge, a free end, and a magnetic member disposed on one of an outer portion of the upper edge, an outer portion of the lower edge, or an outer portion of the free end of each blade at a position corresponding to the winding, whereby the magnetic member can induce and magnetize the winding; and
a heat exchange member connected with the pump case, the heat exchange member having multiple radiating fins and being formed with a heat exchange chamber, the heat exchange chamber communicating with the pump chamber for a cooling liquid to pass through.

2. The water-cooling device as claimed in claim 1, wherein the circuit board is disposed on an inner wall face of the top section, the bottom section or the peripheral section by injection over-molding.

3. The water-cooling device as claimed in claim 1, wherein the driver is made of a nonmetal material.

4. The water-cooling device as claimed in claim 1, wherein the pump case has an inlet in communication with an outlet.

5. The water-cooling device as claimed in claim 1, wherein the radiating fins are arranged at intervals or intersect each other, the radiating fins being in contact with the cooling liquid in the heat exchange chamber.

6. The water-cooling device as claimed in claim 1, wherein the winding is selectively formed/disposed on the circuit board by means of printing, stacking, etching or layout.
